(19) United States
(12) Patent Application Publication
(10) Pub. No.: US 2016/0053694 A1
(43) Pub. Date: Feb. 25, 2016

(54) ENGINE SYSTEM OF DUEL INJECTOR

(71) Applicant: HYUNDAI MOTOR COMPANY, Seoul (KR)

(72) Inventors: Soo Hyung WOO, Yongin-si (KR); Jin Wook SON, Suwon-si (KR); Wonjun LEE, Incheon (KR); Seung Kook HAN, Seoul (KR); Ju Hun LEE, Gwangmyeong-si (KR); Jeong Hwa CHA, Incheon (KR)

(21) Appl. No.: 14/559,830

(22) Filed: Dec. 3, 2014

(30) Foreign Application Priority Data
Aug. 22, 2014 (KR) 10-2014-0109923

(51) Int. Cl. F02D 19/06

(52) U.S. Cl. CPC F02D 19/0647; F02D 19/0665; F02D 19/0689

(57) ABSTRACT

An engine system of a dual injector includes a first injector directly injecting a first fuel into a combustion chamber. A second injector directly injects a second fuel into the combustion chamber. A first fuel tank is connected to the first injector and stores the first fuel therein. A second fuel tank is connected to the second injector and stores the second fuel therein. The first fuel is in a liquid state and the second fuel is in a gas state at room temperature of atmospheric pressure.

### CROSS-REFERENCE TO RELATED APPLICATION

This application claims the benefit of priority to Korean Patent Application No. 10-2014-0109923 filed in the Korean Intellectual Property Office on Aug. 22, 2014, the entire contents of which are incorporated herein by reference.

### TECHNICAL FIELD

The present disclosure is related to an engine system of a dual injector in which two injectors for injecting different types of fuel are disposed in one cylinder.

### BACKGROUND

Natural gas has becoming important resource for future vehicles to replace petroleum.

Currently, a vehicle with a bi-fuel engine that uses gasoline (diesel) and a compressed natural gas (CNG) is available.

Since the bi-fuel engine uses various fuels and fossil energy, air pollution can be reduced. In the bi-fuel engine, one injector is disposed to inject fuel in an intake port, and one injector is disposed to fuel in a cylinder.

However, since gasoline is directly injected into the cylinder and natural gas is injected into the intake port in the bi-fuel engine, the amount of air inflow is reduced, and charging efficiency is deteriorated.

When an intake valve and an exhaust valve are opened to exhaust residual gas of a cylinder in the related art, the fuel that is injected into the intake port can be exhausted through the exhaust side after the combustion.

In addition, the fuel that is injected into the intake port flows backward by pulsation of intake air, wherein harmful fuel gas escapes from the intake port to the outside and fuel gas may explode.

The above information disclosed in this Background section is only for enhancement of understanding of the background of the disclosure, and therefore, it may contain information that does not form the prior art that is already known in this country to a person of ordinary skill in the art.

### SUMMARY

The present disclosure has been made in an effort to provide an engine system of a dual injector having advantages of improving charging efficiency of a cylinder and an output, exhausting residual gas by opening an exhaust valve and an intake valve, and reducing explosion danger or back flow of fuel.

An engine system of a dual injector type according to an exemplary embodiment of the present inventive concept may include a first injector directly injecting a first fuel into a combustion chamber. A second injector directly injects a second fuel into the combustion chamber. A first fuel tank is connected to the first injector and stores the first fuel therein. A second fuel tank is connected to the second injector and stores the second fuel therein. The first fuel is in a liquid state and the second fuel is in a gas state at room temperature of atmospheric pressure.

The first fuel may be one of gasoline, diesel, ethyl alcohol, methyl alcohol, and liquefied petroleum gas (LPG).

The second fuel may be one of compressed natural gas (CNG) and shale gas.

The first injector or the second injector may mechanically inject fuel through by a cam or a rocker arm.

The first injector or the second injector may electrically inject fuel by an electrical signal that is sent to a solenoid actuator or a piezo actuator.

Injection timing of the first injector and the second injector may be controlled to be different.

One of the first injector and the second injector may a perform pilot injection, and the other thereof performs a main injection

One of the first injector and the second injector may perform a main injection, and the other performs a post injection.

An injector tip of one of the first injector and the second injector is disposed at an upper end of a central portion of the combustion chamber, and an injector tip of the other injector is disposed at an edge side of the combustion chamber.

The engine system may include a first fuel pump that pumps the first fuel from the first fuel tank to the first injector, and a second fuel pump that pumps that second fuel from the second fuel tank to the second injector.

In accordance with the present inventive concept, air enters the combustion chamber, in a condition that the intake valve and the exhaust valve are closed, and two types of fuel are injected by two injectors into the cylinder, thus improving charging efficiency of the cylinder.

Further, after combustion, in a condition that the intake valve and the exhaust valve are opened, fuel is not exhausted through an exhaust port, and exhaust gas that resides in the combustion chamber is reduced to increase the air inflow.

In addition, because the fuel is not injected in the intake port, harmful fuel gas is not exhausted through the intake port and explosion thereof is prevented.

### BRIEF DESCRIPTION OF THE DRAWINGS

FIG. 1 is a schematic diagram of an engine system of a dual injector according to an exemplary embodiment of the present inventive concept.

FIG. 2 is a table showing fuel and injector that are applied to an engine of a dual injector according to an exemplary embodiment of the present inventive concept.

FIG. 3 is a graph showing effects of a dual injector according to an exemplary embodiment of the present inventive concept.

### DETAILED DESCRIPTION OF THE EMBODIMENTS

An exemplary embodiment of the present inventive concept will hereinafter be described in detail with reference to the accompanying drawings.

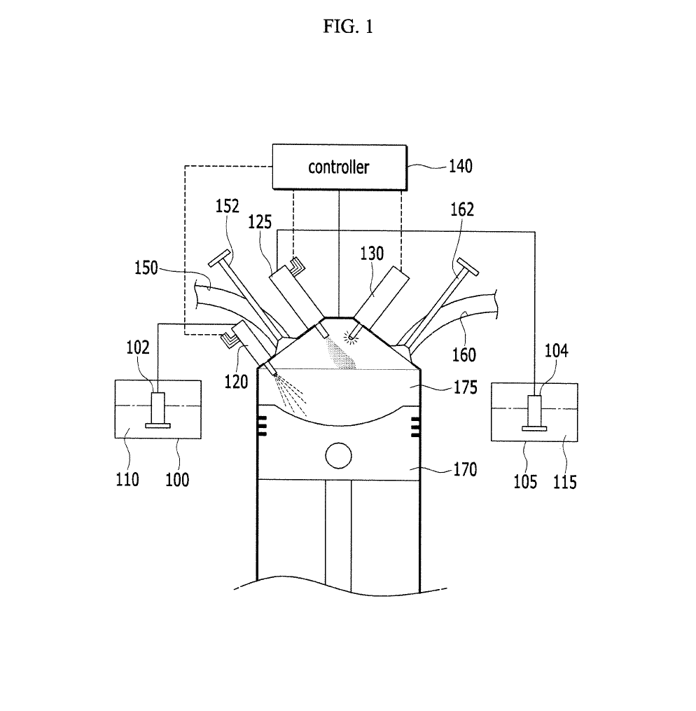

FIG. 1 is a schematic diagram of an engine system of a dual injector according to an exemplary embodiment of the present inventive concept.

Referring to FIG. 1, an engine system of a dual injector includes a controller 140, a first fuel tank 100, a first fuel 110, a first injector 120, an intake valve 152, a second injector 125, a spark plug 130, an exhaust valve 162, a second fuel tank 105, a second fuel 115, a combustion chamber 175, a piston 170, an intake port 150, and an exhaust port 160.

A cylinder is formed in an engine, the piston 170 is disposed in the cylinder, and the combustion chamber 175 is formed at an upper side of the piston 170. The intake port 150 and the exhaust port 160 are connected to upper sides of the combustion chamber 175.

Outside air is supplied to the combustion chamber 175 through the intake port 150, and combustion gas of the combustion chamber 175 is exhausted through the exhaust port 160. The intake valve 152 and the exhaust valve 162 are respectively disposed in the intake port 150 and the exhaust port 160, and the intake valve 152 and the exhaust valve 162 are respectively lifted by a cam of a camshaft (not shown).

The first injector 120 is disposed at an edge portion of the combustion chamber 175, and the second injector 125 and the spark plug 130 are disposed at a central portion of an upper side of the combustion chamber 175.

The first injector 120 is connected to the first fuel tank 10 through a fuel line, and the first fuel 110 that is stored in the first fuel tank 100 is pumped by the first pump 102 to be supplied to the first injector 120 at a predetermined pressure.

The second injector 125 is connected to the second fuel tank 105 through a fuel line, and the second fuel 115 that is stored in the second fuel tank 105 is pumped by the second fuel pump 104 to be supplied to the second injector 125 at a predetermined pressure.

The spark plug 130 generates spark with mixed gas of outside air and fuel that is injected from the first injector 120 or the second injector 125 such that the mixed gas is combusted.

The controller 140 controls the first injector 120, the second injector 125, and the spark plug 130 in accordance with a driving condition of a vehicle, that is, a torque demand, a rotational speed of the engine, a brake operating condition, an accelerator pedal operating condition, an intake air temperature, an intake air flow rate, a transmission operation condition, and an exhaust gas condition. Here, a control method and structure of the engine is well known in the art, thus the detailed description thereof will be omitted.

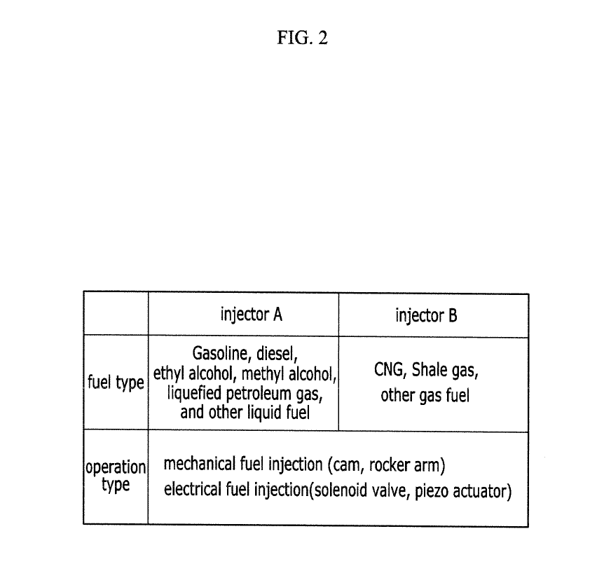

In an exemplary embodiment of the present inventive concept, the first injector 120 and the second injector 125 inject different types of fuel, and the fuel type will be described in detail with reference to FIG. 2.

FIG. 2 is a table showing fuel and injector that are applied to an engine of a dual injector according to an exemplary embodiment of the present inventive concept.

Referring to FIG. 2, the first injector 120 (injector A) injects a liquid state fuel under room temperature and atmospheric pressure, i.e., gasoline, diesel, ethyl alcohol, methyl alcohol, liquefied petroleum gas (LPG), and so on, and the first injector 125 (injector B) injects a gas state fuel under room temperature and atmospheric pressure, i.e., compressed natural gas (CNG), shale gas, and so on.

Further, the first injector 120 and the second injector 125 can be operated mechanically by the cam or a rocker arm or operated electrically by a piezo actuator.

In an exemplary embodiment of the present inventive concept, air enters the combustion chamber 175, two injectors 120 and 125 inject two types of fuel under a condition that the intake valve 152 and the exhaust valve 162 are closed to increase overall charging efficiency of the cylinder and the engine output.

Further, after the combustion process, in a condition that the intake valve 152 and the exhaust valve 162 are opened, fuel is not exhausted through the exhaust port 160, exhaust gas that is remained in the combustion chamber 175 is decreased, outside air inflow amount is increased, and charging efficiency and output are improved.

In addition, fuel is not injected through the intake port 150, and therefore harmfuel fuel gas is not exhausted to an outside and explosion of fuel gas is prevented.

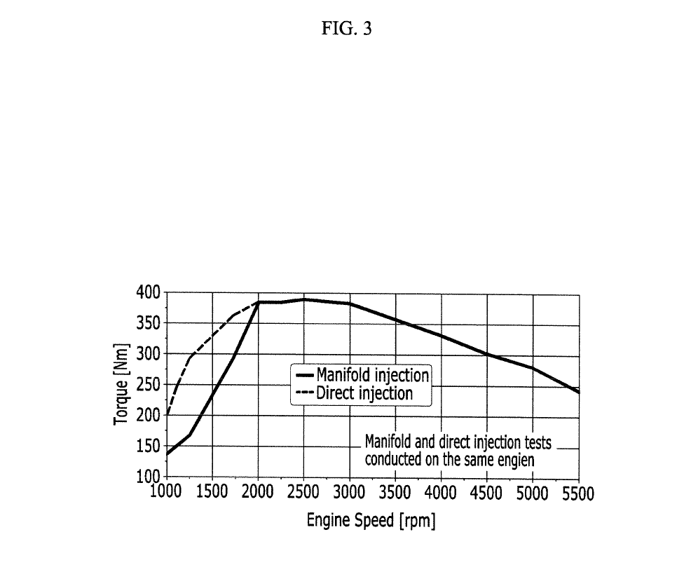

FIG. 3 is a graph showing effects of a dual injector type according to an exemplary embodiment of the present inventive concept.

Referring to FIG. 3, a horizontal axis denotes a rotational speed (RPM), and a vertical axis denotes a torque output. A torque output difference is shown between an intake port injection (manifold injection) and direction injection (combustion chamber).

More particularly, a torque output of a combustion chamber direct injection is higher than that of an intake port injection from 1000 to 2000 RPM based on the engine RPM.

In an exemplary embodiment of the present inventive concept, injection timing of the first injector 120 and the second injector 125 can be controlled to be different from each other.

One injector can perform a pilot injection, a main injection, and a post injection, but in an exemplary embodiment of the present inventive concept, the first injector 120 performs a main injection, the second injector 125 performs a pilot injection or a post injection such that precision of the pilot injection, the main injection, and the post injection can be improved.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. An engine system of a dual injector type, the system comprising:
a first injector direct injecting a first fuel into a combustion chamber;
a second injector direct injecting a second fuel into the combustion chamber;
a first fuel tank connected to the first injector, in which the first fuel is stored; and
a second fuel tank connected to the second injector, in which the second fuel is stored,
wherein the first fuel is in a liquid state and the second fuel is in a gas state at room temperature of atmospheric pressure.

2. The engine system of claim 1, wherein the first fuel is one of gasoline, diesel, ethyl alcohol, methyl alcohol, and liquefied petroleum gas (LPG).

3. The engine system of claim 1, wherein the second fuel is one of compressed natural gas (CNG), and shale gas.

4. The engine system of claim 1, wherein the first injector or the second injector mechanically injects fuel by a cam or a rocker arm.

5. The engine system of claim 1, wherein the first injector or the second injector electrically injects a fuel by an electrical signal that is supplied to a solenoid actuator or a piezo actuator.

6. The engine system of claim 1, wherein injection timing of the first injector and the second injector are controlled to be different.

7. The engine system of claim 6, wherein one of the first injector and the second injector performs a pilot injection and the other thereof performs a main injection.

8. The engine system of claim 6, wherein one of the first injector and the second injector performs a main injection and the other performs a post injection.

9. The engine system of claim 1, wherein an injector tip of one of the first injector and the second injector is disposed at an upper end of a central portion of the combustion chamber, and an injector tip of the other injector is disposed at an edge side of the combustion chamber.

10. The engine system of claim 1, further comprising:
a first fuel pump that pumps the first fuel from the first fuel tank to the first injector; and
a second fuel pump that pumps that second fuel from the second fuel tank to the second injector.

11. The engine system of a dual injector type of claim 1, further comprising:
a controller configured to control the first injector, the second injector in accordance with a driving condition of a vehicle.

12. The engine system of a dual injector type of claim 1, wherein the driving condition includes a torque demand, a rotational speed of an engine, a brake operating condition, an accelerator pedal operating condition, an intake air temperature, an intake air flow rate, a transmission operation condition, and an exhaust gas condition.
